(19) United States
(12) Patent Application Publication
(10) Pub. No.: US 2025/0124322 A1
(43) Pub. Date: Apr. 17, 2025

(54) SYSTEM AND METHOD FOR BACKGROUND-FREE QUBIT STATE MEASUREMENT

(71) Applicant: IonQ, Inc., College Park, MD (US)

(72) Inventors: Jeremy SAGE, Acton, MA (US); Jonathan MIZRAHI, Silver Spring, MD (US)

(21) Appl. No.: 18/907,113

(22) Filed: Oct. 4, 2024

Related U.S. Application Data
(60) Provisional application No. 63/589,556, filed on Oct. 11, 2023.

(51) Int. Cl. G06N 10/40

(52) U.S. Cl. CPC G06N 10/40

(57) ABSTRACT

Aspects of the present disclosure relate generally to systems and methods for use in the implementation and/or operation of quantum information processing (QIP) systems, and more particularly, for background-free qubit measurement. In some aspects, a method includes controlling a photon source oriented to direct photons towards ion(s) in an ion trap to produce photons having a first wavelength for a first time period; stopping the photon source from producing photons having the first wavelength; activating a photon detector configured to detect photons having the first wavelength; controlling the photon source to produce photons having a second wavelength different than the first wavelength for a second time period; detecting photons having the first wavelength during the second time period; and determining, based on detection of photons having the first wavelength during the second time period, that at least one of the one or more ions is in a |1> state.

### CROSS-REFERENCE TO RELATED APPLICATION

This application claims the benefit of U.S. Provisional Patent Application No. 63/589,556, filed Oct. 11, 2023 and hereby incorporates by reference herein the contents of this application.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for background-free measurements of qubit states.

In some aspects, a method for background-free measurement of qubit states includes controlling a photon source to produce photons having a first wavelength for a first time period. The photon source is oriented such that the photons having the first wavelength are directed towards one or more ions in an ion trap. The method includes: stopping the photon source from producing photons having the first wavelength; activating a photon detector configured to detect photons having the first wavelength; controlling the photon source to produce photons having a second wavelength different than the first wavelength for a second time period; detecting, with the photon detector, photons having the first wavelength during the second time period; and determining, based on detection of photons having the first wavelength during the second time period, that at least one of the one or more ions is in a |1 [symbol] state.

In some aspects a system for background-free measurement of qubit states includes an ion trap, a first photon source, a first photon detector, a second photon source, and a second photon detector. The ion trap includes one or more trapped ions. The first photon source is configured to produce photons having a first wavelength configured to cause the one or more trapped ions to transition from a ground state to an excited state. The first photon detector is configured to detect photons having the first wavelength. The second photon source is configured to produce photons at a second wavelength configured to cause the one or more trapped ions to transform from a meta-stable state to the excited state. The second wavelength is different than the first wavelength. The second photon detector is configured to detect photons having the second wavelength.

In some aspects, a method for background-free measurement of qubit states includes: controlling a photon source to produce photons having a first wavelength for a first time period. The photon source is oriented such that the photons having the first wavelength are directed towards one or more ions in an ion trap. The method includes activating a photon detector configured to detect second photons during the first time period. The second photons have a second wavelength that is different than the first wavelength. The method includes: stopping the photon source from producing photons having the first wavelength; stopping the photon detector from detecting photons having the second wavelength; activating a photon detector configured to detect photons having the first wavelength; controlling the photon source to produce photons having the second wavelength for a second time period; detecting, with the photon detector, photons having the first wavelength during the second time period; and determining, based on detection of photons having the first wavelength during the second time period or based on detection of photons having the second wavelength during the first time period, that at least one of the one or more ions is in a |1 [symbol] state.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions of a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example system for determining background-free measurements of qubit states in accordance with aspects of this disclosure.

FIG. 5 illustrates a schematic representation of a method for background-free measurement of qubit states in accordance with aspects of this disclosure.

FIG. 6 illustrates a flow diagram of the method of FIG. 5 in accordance with aspects of this disclosure.

FIG. 7 illustrates a timing diagram of the method of FIG. 5 in accordance with aspects of this disclosure.

FIG. 8 illustrates another example system for determining background-free measurements of qubit states in accordance with aspects of this disclosure.

FIG. 9 illustrates a flow diagram of the method of FIG. 8 in accordance with aspects of this disclosure.

FIG. 10 illustrates a timing diagram of the method of FIG. 8 in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

During QIP processes, qubits (e.g., trapped ions) are in a quantum superposition of two states, |0 [symbol] and |1 [symbol] , such that each of the trapped ions can be in one of two states |0 [symbol] and |1 [symbol] . The states of the trapped ions are determined during operations of QIP systems, for example by exciting the trapped ions with photons and measuring the presence or absence of photons emitted by the ions. The photons emitted by the ions are typically the same wavelength as the photons used to excite the ions from the ground state (typically the S_{1/2} energy level) to the excited state (typically the P_{1/2} energy level). In conventional QIP systems, the photon source (e.g., laser) which produces the photons used to excite the ions is powered on when the photon detectors are also operating. However, the photons used to excite the ions may reflect off of nearby surfaces (instead of the ions), causing photon scatter, which can be detected by photon detectors. As QIP systems become smaller, scatter becomes more likely, as components of the QIP system are closer in proximity to each other. This can lead to measurement errors, because these measured photons are the result of scatter, instead of emission from the ions. In conventional systems, spatial filtering is typically used to reduce the amount of scattered photons measured by the photon detectors. However, spatial filtering is imperfect and can still lead to measurement errors.

A portion of the ions in the excited state may fall into a meta-stable state (typically the D_{3/2} energy level). In some aspects, a second photon source (e.g., laser) is configured to produce photons having a wavelength that is configured to cause the ions in the meta-stable state to transition to the excited state. In such conventional systems, the first and second photon sources are turned on during the same time period.

Conventionally, some systems address measurement errors due to scatter by providing (e.g., via a first laser) photons at a first wavelength to excite the ions from a ground state (typically the S_{1/2} energy level) to an intermediate state, such as the D_{3/2} energy level. However, this transition can require large amounts of energy. Simultaneously, the photons at a second wavelength are provided (e.g., via a second laser) to excite the ions from the intermediate state to the excited state (typically the P_{1/2} energy level). Still simultaneously, a photon detector that detects photons emitted from the exited ion as it transitions from the excited state to the ground state is operational. The photons emitted as the ion transitions from the excited state to the ground state are at different wavelengths than either the first or second wavelengths provided by the first and second lasers. Therefore, any scatter that occurs is at either of the first and second wavelengths, and may will not be detected by the photon detector. However, this method may require a specialized narrow-linewidth laser, and the necessary wavelength may be challenging to work with. For example, in configurations in which the ions include barium +1 (Ba⁺) ions, wavelengths of about 2000 nm may be necessary to cause the ions to transition from the ground state to the D_{3/2} state. Further, such methods require about 10-100 milliwatts (mW) to achieve the requisite measurement speeds.

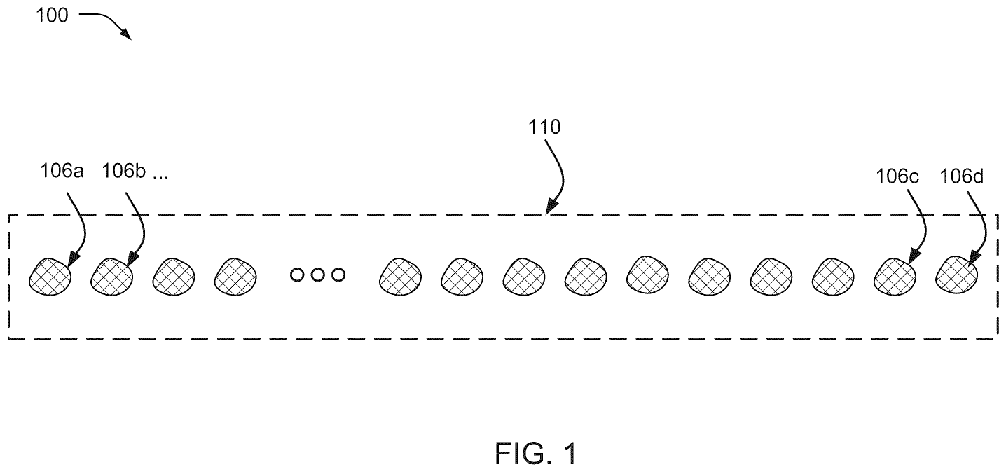

Solutions to the issues described above are explained in more detail in connection with FIGS. 1-10, with FIGS. 1-3 providing a background of QIP systems or quantum computers, and more specifically, of atomic-based QIP systems or quantum computers.

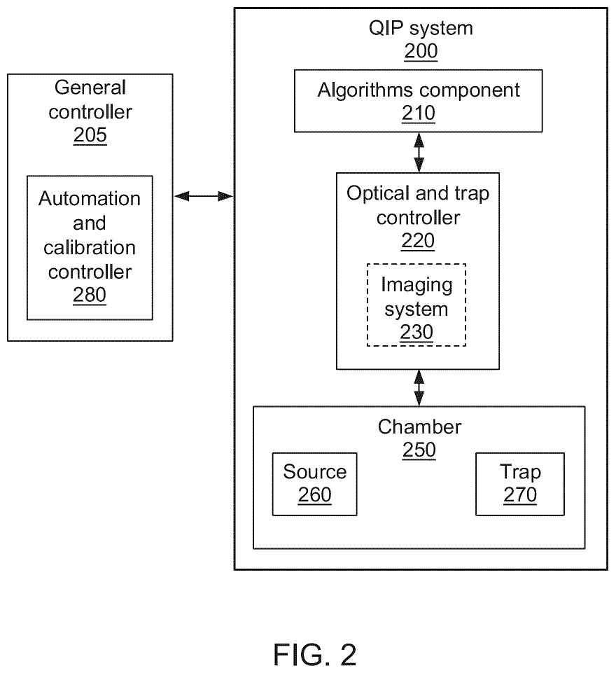

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions) or Barium ions (e.g., Ba⁺) for example. In the exemplary aspect, the ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions in the ion trap may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the optical and trap controller 220, the ion trap 270, the lasers, the optical systems and/or assemblies, the optical components, and the imaging system 230.

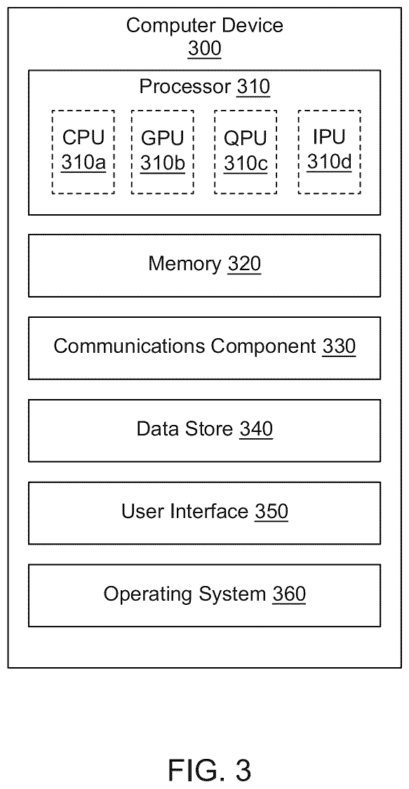

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, the aspects described herein provide systems and methods for background-free measurements of qubit states, as well as the detection of absence or presence of a particular number of ions in an array; for example, these systems and methods can be used to detect the loss of an ion or the presence of an ion of a differing species or isotope than those used for qubits. In general, a qubit is the basic unit of information in the quantum computing systems according to the example aspects described herein. The qubits are in a quantum superposition of two states, |0 [symbol] and |1 [symbol] , such that each of the qubits can be in one of the two states |0 [symbol] and |1 [symbol] . During QIP operations, it is necessary to determine the state of the qubits. In this example, the state of the ions (e.g., trapped ions 27λₐ to 27λₙ) can represent qubits according to an example aspect. In order to determine the state of the qubits, the qubits can be excited with a photon of light at a particular wavelength based on the type of ion of the qubit. In aspects in which the qubit is in the |0 [symbol] state, the qubit will not transition to the excited state in response to absorbing a photon from the optical beam. In aspects in which the qubit is in the |1 [symbol] state, the qubit will transition from a ground state to an excited state in response to absorbing a photon from the optical beam, and will emit a photon as the qubit transitions from the excited state to the ground state, which can be detected by the imaging system 230.

The aspects described in greater detail below are described with respect to an example aspect in which the qubits include barium ions (Ba⁺). In other aspects, the systems and methods described herein can be used for ions having similar configurations, such as, for example, ions having at least two D energy levels, one of which can be used as a shelving level, and one of which can be used as a meta-stable state between the ground and excited states. The systems and methods described herein work generally for ions or neutral atoms that have at least one energy level that can be used for shelving population from one of the qubit energy levels, as well as at least three additional energy levels that can be can be used in the photon detection cycle such that (1) two of these energy levels have long enough lifetimes to enable population storage during the stroboscopic pulse sequence; (2) transitions between at least two pairs of the these energy levels can be driven with lasers and via spontaneous emission, with wavelengths different enough to be able to be spectrally filtered from one another; (3) the two pairs share one energy level in common—also known as a “lambda” system; and (4) population in the pairs of energy levels used in the detection cycle have insignificant probability to decay to the level used for shelving; and (5) the lasers used to drive transitions in the detection cycle have insignificant probability of driving population to the shelving level. In some aspects, the ions may be ytterbium ions (Yb⁺), calcium ions (Ca⁺), strontium ions (Sr⁺), or radium (Ra⁺) ions. In such aspects, the specific wavelengths for the shelving, pumping, and dumping phases may be different than the wavelengths described below, which are for Ba⁺. For example, in aspects in which the ions are Sr⁺ ions, the shelving wavelength (λ_{S}) is 674 nanometers (nm), the pumping wavelength ((λ_{P}) is 422 nm, and the dumping wavelength (λ_{D}) is 1092 nm. In aspects in which the ions are Ca⁺ ions, the shelving wavelength (λ_{S}) is 729 nanometers (nm), the pumping wavelength (λ_{P}) is 397 nm, and the dumping wavelength ((λ_{D}) is 866 nm.

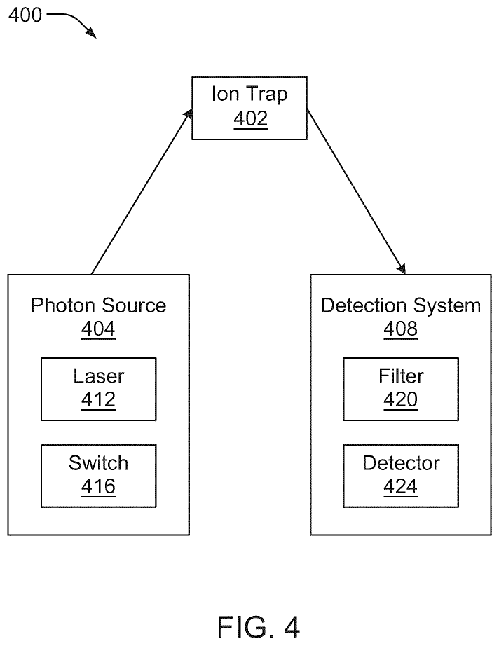

FIG. 4 illustrates a block diagram of a system 400 for determining background-free measurements of qubit states according to an exemplary aspect. As shown in FIG. 4, the system 400 includes a ion trap 402, a photon source 404, and a detection system 408. The ion trap 402 may correspond to the ion trap 270 discussed above. The photon source 404 can correspond to the source 260 as described above and can include one or more lasers 412 and is configured to produce photons at two or more wavelengths. The photon source 404 can independently switch the one or more lasers 412 on and off via an optical switch 416. The optical switch 416 may be or include an acousto-optic deflector (AOD) or an acousto-optic modulator (AOM) configured to switch between the wavelength of photons provided by the photon source 404. In other aspects, the optical switch 416 may include an electro-optic modulator (EOM), a microelectromechanical systems (MEMS)-based switch, a thermo-optic based switch, and/or a mechanical shutter or chopper.

The detection system 408 can correspond to the imaging system 230 described above. The detection system 408 is configured to detect photons at particular wavelengths. For example, the detection system 408 includes a filter 420 configured to pass a predefined wavelength or range of wavelengths of photon to a photon detector 424. The predefined wavelength or range of wavelengths that the filter 420 is configured to pass is based on the type of atom or ion used in the qubit. As described in greater detail below, the filter 420 is configured to pass photons having a pumping wavelength λp. For example, in aspects in which the ion is Ba⁺, the filter 420 may be configured to pass photons at 493 nanometers (nm) and block photons at other wavelengths. In some aspects, the filter 420 may be a dichroic filter configured to pass photons at a first wavelength and reflect photons at a second wavelength. In this case, two detectors can be used to stroboscopically detect both transmitted (detector 1) and reflected (detector 2) photons in order to increase the total number of detected photons. In aspects in which the ion is Ba⁺, the first wavelength may be 493 nm and the second wavelength may be 650 nm. In some aspects, the photon detector 424 may be or include a camera. In other aspects, the photon detector 424 may be or include a photomultiplier tube (PMT), avalanche photodiode (APD), superconducting nanowire single-photon detector (SNSPD), and so forth.

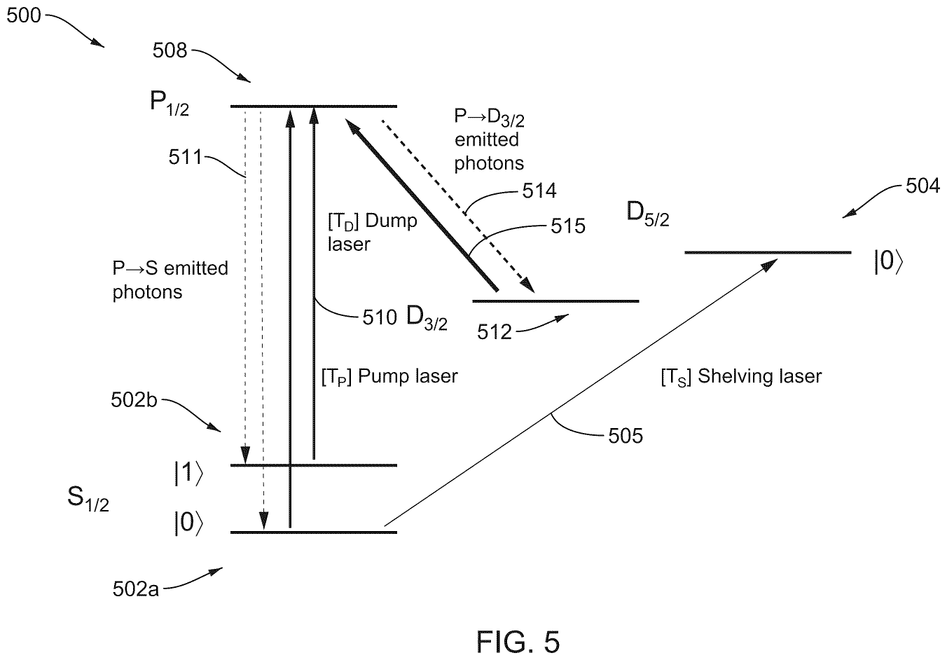

An example method for background-free measurement of qubit states is shown in FIGS. 5-7. In some aspects, the method shown in FIGS. 5-7 may be a computer-implemented method. In some aspects, the method shown in FIGS. 5-7 may be implemented manually or a combination of manually and by computer. In some aspects, the example method for background-free measurement of qubit states may be carried out using the system 400 shown in FIG. 4 and the general controller 205 and/or the optical and trap controller 220.

FIG. 5 illustrates a schematic representation 500 of the example method for background-free measurement of qubit states for Ba⁺ according to an exemplary aspect. In FIG. 5, absorbed photons are shown using solid lines and emitted photons are showed using dashed lines.

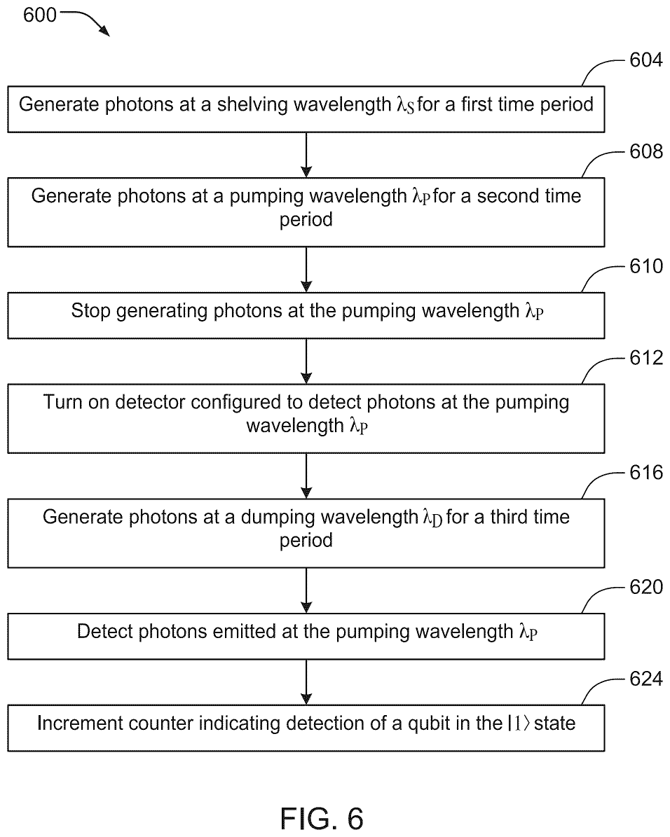

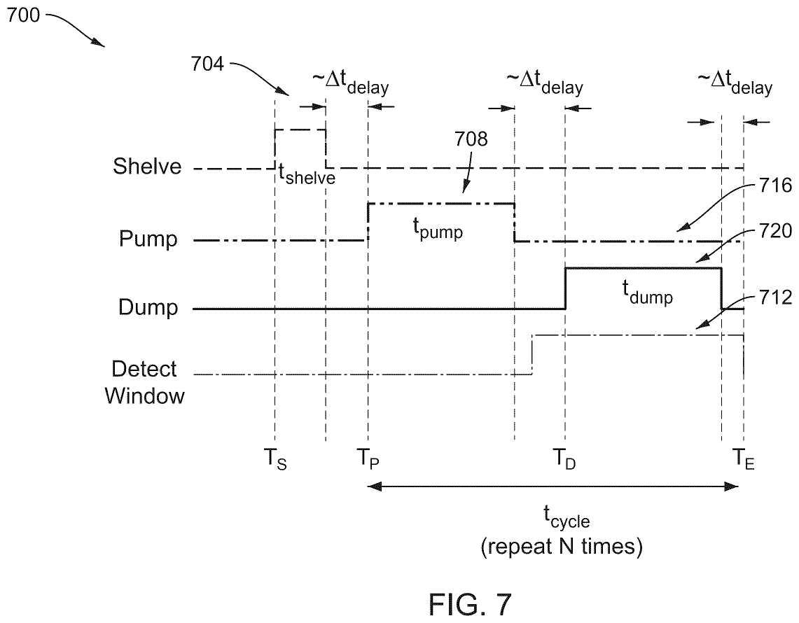

FIG. 6 illustrates a flow diagram 600 of the method for background-free measurement of qubit states according to an exemplary aspect. FIG. 7 illustrates a timing diagram 700 of the method for background-free measurement of qubit states according to an exemplary aspect.

As described above, at the initiation of the method, each of the qubits (e.g., ions) in the ion trap 402 can be in either the |0 [symbol] state or the |1 [symbol] state. At 604, the photon source 404 is controlled to generate photons at a shelving wavelength λ_{S} and provide the photons at the shelving wavelength λ_{S} for a first or shelving time period tₛₕₑₗᵥₑ, which is shown by arrow 704 (FIG. 7). The photons at the shelving wavelength λ_{S} have the required energy to excite an electron in the S_{1/2} energy level 502a of qubits in the |0 [symbol] state to transition to a first meta-stable state or shelved state 504 (FIG. 5), shown by arrow 505. The shelved state has a long lifetime and the population of shelved qubits stays in the shelved state for a time much longer than the measurement time. In the illustrated aspect, the first meta-stable state is the D_{5/2} energy level of the Ba⁺ ion. In aspects in which the ion is Ba⁺, λ_{S} is 1762 nm. The qubits in the |0 [symbol] state remain in the shelved state for the shelved time period tₛₕₑₗᵥₑ. Shelving the qubits in the |0 [symbol] state can prevent qubits in the |1 [symbol] state from erroneously being identified as being in the |0 [symbol] state. The photon source 404 is controlled to stop providing photons at the shelving wavelength λ_{S} at the end of the shelving time period tₛₕₑₗᵥₑ. As shown in FIG. 7, the photon source 404 only produces the shelving wavelength λ_{S} during 604.

At 608, the photon source 404 is controlled to generate photons at a pumping wavelength λ_{P} and provide the photons at the pumping wavelength λ_{P} for a second or pumping time period tₚᵤₘₚ, which is shown by arrow 708 (FIG. 7). The photons at the pumping wavelength λ_{P} have the required energy to excite an electron in the S_{1/2} energy level 502b (FIG. 5) of the qubits in the |1 [symbol] state to transition to the P_{1/2} energy level 508, shown by arrow 510. During the pumping time period tₚᵤₘₚ, a portion of the excited electrons in the P_{1/2} energy level 508 may spontaneously transition to the S_{1/2} energy level 502b, as shown by arrow 511. These electrons emit a photon at the pumping wavelength λ_{P} as they transition back to the S_{1/2} energy level 502b. Electrons of the qubits in the |1 [symbol] state may transition between the S_{1/2} energy level 502b and the P_{1/2} energy level 508 multiple times during the pumping time period tₚᵤₘₚ, absorbing photons at the pumping wavelength λ_{P} as they transition to the P_{1/2} energy level 508 and emitting photons at the pumping wavelength λ_{P} as they transition to the S_{1/2} energy level 502b. During the pumping time period tₚᵤₘₚ, a portion of the excited electrons in the P_{1/2} energy level 508 may transition to a second meta-stable state 512 (FIG. 5), as shown by arrow 514, emitting a photon of light at a dumping wavelength λD. However, the photons at the pumping wavelength λ_{P} do not have the required energy for the electrons in the second meta-stable state 512 to return to the P_{1/2} energy level 508, so these electrons remain in the second meta-stable state 512. In the illustrated aspect, the second meta-stable state 512 is the D_{3/2} energy level of the Ba⁺ ion. In aspects in which the ion is Ba⁺, λ_{P} is 493 nm. A branching ratio, Γ_{BR}, indicates the proportion of qubits in the excited state that transition to the ground state or the second meta-stable state. For Ba⁺, Γ_{BRS} is 0.73 for the transition from the excited state to the ground state and Γ_{BRD} is 0.27 from the transition from the excited state to the second meta-stable state. This means that a particular qubit in the excited state has a 73% chance of transitioning to the ground state and a 27% chance of transitioning to the second meta-stable state.

At 610, the photon source 404 is controlled (e.g., instructed or commanded) to stop providing photons at the pumping wavelength λ_{P} at the end of the pumping time period tₚᵤₘₚ. As shown in FIG. 7, the photon source 404 only produces the pumping wavelength λ_{P} during 608 (as shown by arrow 708).

At 612, the detection system 408 is turned on, as shown by arrow 712 (FIG. 7). Since the photon source 404 is not producing photons at the pumping wavelength λ_{P} (as shown by arrow 716) when the detection system 408 is turned on, and since the filter 420 is configured to only pass photons at the pumping wavelength λ_{P}, the detector 424 does not detect any photons at this time. The detection system remains turned on for a third detection time period tp. As shown in FIG. 7, the detection system 408 is not turned on when the photon source 404 produces photons at the pumping wavelength λ_{P}. Therefore, the detection system 408 does not detect any scatter at λ_{P} that may occur at 608.

At 616, the photon source 404 is controlled to generate photons at a dumping wavelength λ_{P} and provide the photons at the dumping wavelength λ_{P} for a fourth or dumping time period t_{dump}, which is shown by arrow 720 (FIG. 7). The photon source 404 does not produce photons at the pumping wavelength λ_{P} during the dumping period t_{dump}. The photons at the dumping wavelength λ_{P} have the required energy to excite an electron of the qubits in the |1 [symbol] in the second meta-stable state 512 (e.g., the D_{3/2} energy level for Ba⁺) state to transition to the Pin energy level 508 (FIG. 5), as shown by arrow 515. In aspects in which the qubit is the Ba⁺ ion, the dumping wavelength λ_{P} is 650 nm.

During the dumping time period t_{dump}, a portion of the electrons in the P_{1/2} energy level 508 may spontaneously transition to the second meta-stable state 512. These electrons emit a photon at the dumping wavelength λ_{P} as they transition to the second meta-stable state 512. Electrons may transition between the P_{1/2} energy level 508 and the second meta-stable state 512 multiple times during the dumping time period t_{dump}, absorbing photons at the dumping wavelength λ_{P} as they transition to the P_{1/2} energy level 508 and emitting photons at the dumping wavelength λ_{P} as they transition to the second meta-stable state 512. During the pumping time period tₚᵤₘₚ, a portion of the excited electrons in the P_{1/2} energy level 508 may spontaneously transition to the S_{1/2} energy level 502b. These electrons emit a photon at the pumping wavelength λ_{P} as they transition to the S_{1/2} energy level 40λ_{b}. As described above, for Ba⁺, each qubit has a 73% chance of transitioning from the P_{1/2} energy level to the S_{1/2} energy level, for example. Emitted photons at the pumping wavelength λ_{P} may be detected by the detector 424 at 620. Since the photon source 404 does not produce photons at the pumping wavelength λ_{P} during the dumping time period t_{dump} or during the detection time period t_{D}, the only source of photons at the pumping wavelength λ_{P} during the dumping time period t_{dump} is electrons from qubits in the |1 [symbol] state transitioning from the P_{1/2} energy level 508 to the S_{1/2}. Therefore, there is no background light at the pumping wavelength λ_{P} when photons emitted by qubits in the |1 [symbol] state are being detected. Therefore, there is no scatter at the pumping wavelength λ_{P} when the photon detector 424 is turned on. As shown in FIG. 7, the photon source 404 only produces the dumping wavelength λ_{P} during 620.

According to an exemplary aspect, the time tₚᵤₘₚ can be chosen to achieve a high probability (e.g., >90%) to cause the ion to transition to the D_{3/2} level from the S_{1/2} level via the P_{1/2} level by spontaneously decaying and emitting a photon. Moreover, the time t_{dump} can be chosen to achieve a high probability (e.g., >90%) to cause the ion to transition to the S_{1/2} level from the D_{3/2} level via the P_{1/2} level by spontaneously decaying and emitting a photon. These probabilities, and the corresponding tₚᵤₘₚ and t_{dump} times, are determined by the spontaneous emission time of the P_{1/2} state (e.g., approximately 10 nanoseconds (ns) for Ba⁺), and the branching ratios Γ_{BRS} and Γ_{BRD}. For Ba⁺, these times are approximately 150 and 50 ns for tₚᵤₘₚ and t_{dump}, respectively.

At 624, a counter indicating that a qubit in the |1 [symbol] state has been detected is incremented in response to detecting a photon at the pumping wavelength λ_{P} at 620 (e.g., shown by arrow 708).

In some aspects, a delay time Δt_{delay} may occur after any of steps 608-624.

Moreover, steps 608-624 can generally be considered a measurement cycle that takes a measurement time t_{cycle} according to an exemplary embodiment. The amount of time that the qubits in the |0 [symbol] state remain in the first meta-stable state 504 is longer than the measurement time t_{cycle}. Further, the meta-stable state 504, as well as the particular states, such as the S_{1/2}, P_{1/2}, and D_{3/2} states, are chosen such that no transitions to or from the meta-stable state can occur with significant probability during any time except when photons at wavelength λ_{S} are present. This configuration protects the population from the |0 [symbol] state that is shelved in the meta-stable state from mixing with population in the |1 [symbol] state during the measurement process (e.g., 608-624). The chosen states can deliver this protection through requirements such as energy and/or angular momentum conservation.

In some aspects of the present disclosure, 608-624 may be repeated N times to increase the fidelity of the detection of qubits in the |1 [symbol] state. In such aspects, the amount of time that the qubits in the |0 [symbol] state remain in the first meta-stable state 504 is longer than the combined measurement times t_{cycle} of all N measurement cycles.

As shown in FIG. 7, the measurement method ends at time T_{E}.

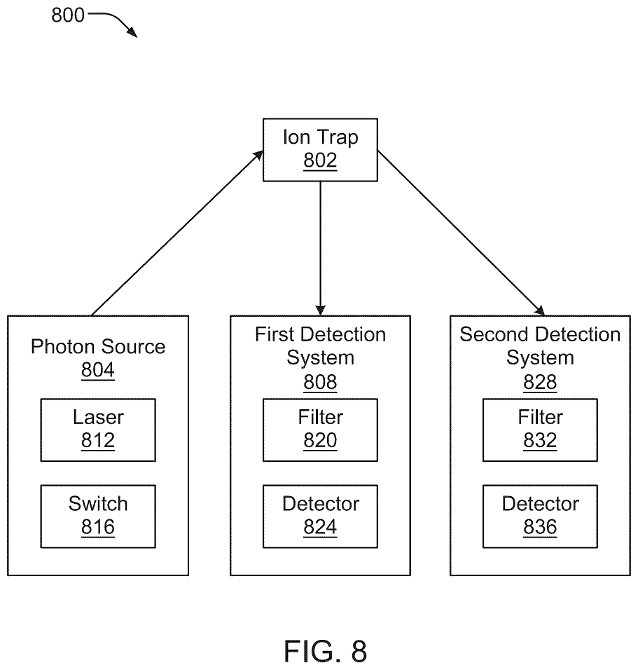

FIG. 8 illustrates a block diagram of a system 800 for determining background-free measurements of qubit states according to another exemplary aspect. The system 800 is substantially similar to the system 400 and is only described in detail to the extent that it differs from the system 400. Like parts between the system 400 and the system 800 are shown using like numbers.

As shown in FIG. 8, detection system 808 is a first detection system. As described in greater detail below, the first detection system 808 is configured to detect photons corresponding to a pumping wavelength λ_{P}. For example, the detection system 808 includes a filter 820 configured to pass a predefined wavelength or range of wavelengths of photon to a photon detector 824. The predefined wavelength or range of wavelengths that the filter 820 is configured to pass is based on the type of atom or ion. For example, in aspects in which the qubit is the Ba⁺ ion, the filter 820 may be configured to pass photons at 493 nm. In other aspects, the filter 820 may be a dichroic filter configured to pass photons at a first wavelength and reflect photons at a second wavelength. In aspects in which the qubit is the Ba⁺ ion, the first wavelength may be 493 nm and the second wavelength may be 650 nm.

The system 800 includes a second detection system 828. As described in greater detail below, the second detection system 828 is configured to detect photons corresponding to a dumping wavelength 2p. For example, the detection system 828 includes a filter 832 configured to pass a predefined wavelength or range of wavelengths of photon to a photon detector 836. The predefined wavelength or range of wavelengths that the filter 832 is configured to pass is based on the type of atom or ion. For example, in aspects in which the qubit is Ba⁺, the filter 420 may be configured to pass photons at 650 nm. In other aspects, the filter 832 may be a dichroic filter configured to pass photons at a first wavelength and reflect photons at a second wavelength. In aspects in which the qubit is the Ba⁺ ion, the first wavelength may be 650 nm and the second wavelength may be 493 nm.

In some aspects, the first and second detection systems 808, 828 can correspond to the imaging system 230 described above.

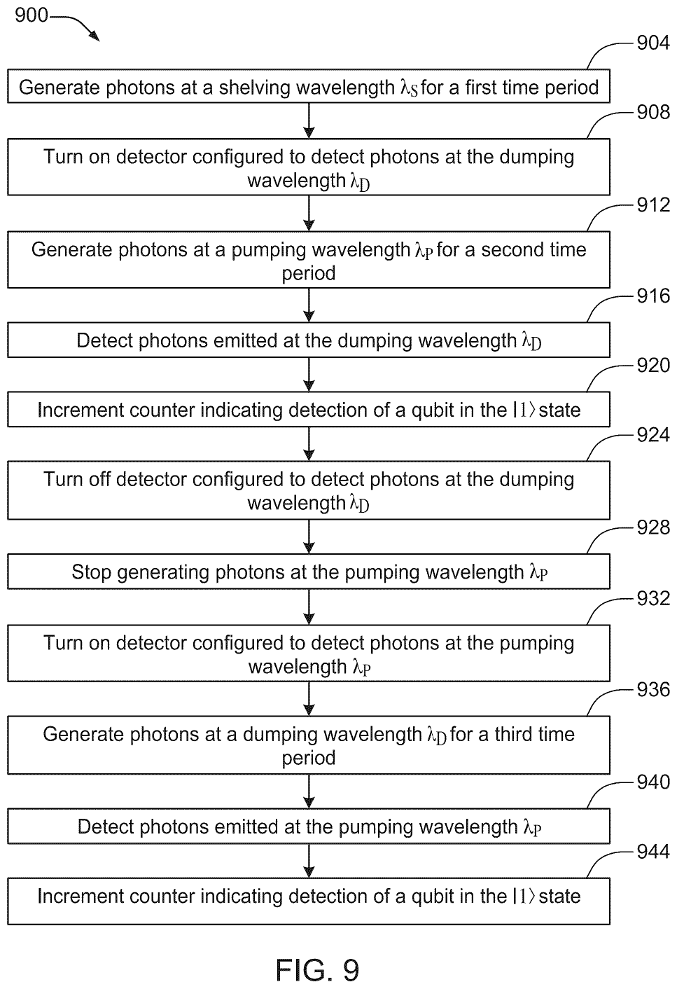

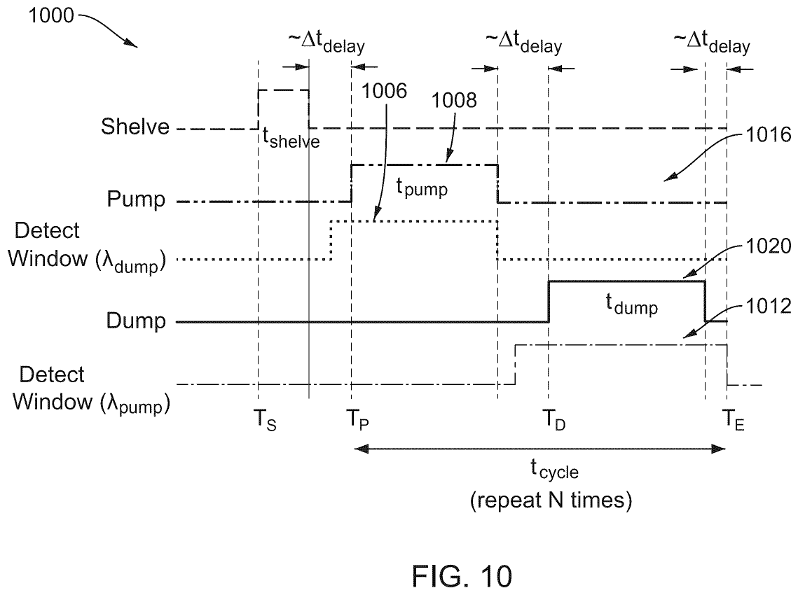

FIGS. 9 and 10 are only discussed in detail to the extent that they differ from FIGS. 6 and 7, respectively. Additionally, the method 900 shown in FIG. 9 and the timing diagram 1000 of FIG. 10 is also discussed with regard to FIG. 5, because the electrons behave in the same manner during both the methods shown and described with regard FIGS. 6-7 and FIGS. 9-10. In some aspects, the method shown in FIGS. 9-10 may be a computer-implemented method. In some aspects, the method shown in FIGS. 9-10 may be implemented manually or a combination of manually and by computer.

At the initiation of the method shown in FIGS. 9-10, each of the qubits (e.g., ions) in the ion trap 802 can be in either the |0 [symbol] state or the |1 [symbol] state. 904 is substantially the same as 604 and is not described in detail herein.

At 908, the second detection system 828 is turned on, as shown by arrow 1006 (FIG. 10). Since the photon source 804 is not producing photons at a dumping wavelength λ_{P} (as shown in FIG. 10) when the second detection system 828 is turned on, and since the filter 832 is configured to only pass photons at the dumping wavelength λ_{P}, the second detector 836 does not detect any photons at this time. The second detection system 828 remains turned on throughout the pumping time period tₚᵤₘₚ.

At 912, the photon source 804 is controlled to generate photons at a pumping wavelength λ_{P} and provide the photons at the pumping wavelength λ_{P} for a second or pumping time period tₚᵤₘₚ, which is shown by arrow 1008 (FIG. 10).

During the pumping time period tₚᵤₘₚ, a portion of the excited electrons in the P_{1/2} energy level 508 may transition to a second meta-stable state 512 (FIG. 5), as shown by arrow 514, emitting a photon of light at the dumping wavelength λ_{P}. This photon at the dumping wavelength λ_{P} may be detected by the detector 836 at 916. Since the photon source 804 does not produce photons at the dumping wavelength λ_{P} during the pumping time period tₚᵤₘₚ, the only source of photons at the dumping wavelength λ_{P} during the pumping time period tₚᵤₘₚ is electrons from qubits in the |1 [symbol] state transitioning from the P_{1/2} energy level 508 to the second meta-stable state 512. Therefore, there is no background light at the dumping wavelength λ_{P} (which can cause scatter) when photons emitted by qubits in the |1 [symbol] state transitioning from the P_{1/2} energy level 508 to the second meta-stable state 512 are being detected during 916. As shown by arrow 1008 in FIG. 10, the photon source 404 only produces the pumping wavelength λ_{P} during 916.

At 920, a counter indicating that a qubit in the |1 [symbol] state has been detected is incremented in response to detecting a photon at the dumping wavelength λ_{P} at 924.

At 924, the second detection system 828 is turned off.

At 928, the photon source 804 is controlled to stop producing photons at the dumping wavelength λ_{P}.

At 932, the first detection system 808 is turned on, as shown by arrow 1012 (FIG. 10). Since the photon source 804 is not producing photons at the pumping wavelength λ_{P} (as shown by arrow 1016) when the first detection system 808 is turned on, and since the filter 820 is configured to only pass photons at the pumping wavelength λ_{P}, the detector 824 does not detect any photons at this time. The first detection system 808 remains turned on for a third or detection time period tp. As shown in FIG. 10, the first detection system 808 is not turned on when the photon source 804 produces photons at the pumping wavelength λ_{P}. Therefore, the detection system 808 does not detect any scatter at λ_{P} that may occur at 912.

At 936, the photon source 804 is controlled to generate photons at a dumping wavelength λ_{P} and provide the photons at the dumping wavelength λ_{P} for a fourth or dumping time period t_{dump}, which is shown by arrow 1020 (FIG. 10). The photon source 804 does not produce photons at the pumping wavelength λ_{P} during the dumping period t_{dump}. The photons at the dumping wavelength λ_{P} have the required energy to excite an electron of the qubits in the |1 [symbol] state in the second meta-stable state 512 (e.g., the D_{3/2} energy level for Ba⁺) state to transition to the P_{1/2} energy level 508 (FIG. 5), as shown by arrow 515. In aspects in which the qubit is the Ba⁺ ion, during the dumping time period t_{dump}, a portion of the electrons in the Pin energy level 508 may spontaneously transition to the second meta-stable state 512. These electrons emit a photon at the dumping wavelength λ_{P} as they transition to the second meta-stable state 512. During the pumping time period tₚᵤₘₚ, a portion of the excited electrons in the P_{1/2} energy level 508 may spontaneously transition to the S_{1/2} energy level 502b. These electrons emit a photon at the pumping wavelength λ_{P} as they transition to the S_{1/2} energy level 502b.

Emitted photons at the pumping wavelength λ_{P} may be detected by the detector 424 at 940. Since the photon source 404 does not produce photons at the pumping wavelength λ_{P} during the dumping time period t_{dump} or during the detection time period t_{D}, the only source of photons at the pumping wavelength λ_{P} during the dumping time period t_{dump} is electrons from qubits in the |1 [symbol] state transitioning from the P_{1/2} energy level 508 to the S_{1/2} energy level. Therefore, there is no background light at the pumping wavelength λ_{P} when photons emitted by qubits in the |1 [symbol] state are being detected. Therefore, there is no scatter at the pumping wavelength λ_{P} when the photon detector 824 is turned on. As shown in FIG. 10, the photon source 804 only produces the dumping wavelength λ_{D} during 936.

At 944, a counter indicating that a qubit in the |1 [symbol] state has been detected is incremented in response to detecting a photon at the pumping wavelength λ_{P} at 940.

In general, steps 908-944 can be considered a measurement cycle that takes a measurement time t_{cycle} according to an exemplary aspect. The amount of time that the qubits in the |0 [symbol] state remain in the first meta-stable state 504 is longer than the measurement time t_{cycle}. In some aspects of the present disclosure, 908-944 may be repeated N times to increase the fidelity of the detection of qubits in the |1 [symbol] state. In such aspects, the amount of time that the qubits in the |0 [symbol] state remain in the first meta-stable state 504 is longer than the combined measurement times t_{cycle} of all N measurement cycles. In the aspect illustrated in FIGS. 9-10, qubits can be detected at steps 920 and/or 944. Therefore, it make take fewer cycles to accurately determine the qubit states.

As shown in FIG. 10, the measurement method ends at time T_{E}.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for background-free measurement of qubit states, the method comprising:
controlling a photon source to produce photons having a first wavelength for a first time period, wherein the photon source is oriented such that photons having the first wavelength are directed towards one or more ions in an ion trap;
stopping the photon source from producing photons having the first wavelength;
activating a photon detector configured to detect photons having the first wavelength;
controlling the photon source to produce photons having a second wavelength different than the first wavelength for a second time period;
detecting, with the photon detector, photons having the first wavelength during the second time period; and
determining, based on detection of photons having the first wavelength during the second time period, that at least one of the one or more ions is in a |1 [symbol] state.

2. The method of claim 1, wherein photons having the first wavelength cause the one or more ions to transition from a ground state to an excited state; and
wherein photons having the second wavelength cause the one or more ions to transition from a meta-stable state to the excited state.

3. The method of claim 2, wherein photons having the first wavelength detected during the second time period are emitted by at least one of the one or more ions transitioning from the excited state to the ground state.

4. The method of claim 1, wherein the one or more ions is a barium ion, a ytterbium ion, a calcium ion, a strontium ion, or a radium ion.

5. The method of claim 1, wherein the photon detector includes a filter configured to pass photons having the first wavelength and block photons having the second wavelength.

6. The method of claim 1, wherein the method is a computer-implemented method.

7. A system for background-free measurement of qubit states, the system comprising:
an ion trap comprising one or more trapped ions;
a first photon source configured to produce photons having a first wavelength configured to cause the one or more trapped ions to transition from a ground state to an excited state;
a first photon detector configured to detect photons having the first wavelength;
a second photon source configured to produce photons at a second wavelength configured to cause the one or more trapped ions to transform from a meta-stable state to the excited state, wherein the second wavelength is different than the first wavelength; and
a second photon detector configured to detect photons having the second wavelength.

8. The system of claim 7, wherein the first photon detector is turned on when the first photon source is turned off.

9. The system of claim 8, wherein the first photon detector includes a filter configured to pass photons having the first wavelength and block photons having the second wavelength.

10. The system of claim 7, wherein the second photon detector is turned on when the second photon source is turned off.

11. The system of claim 10, wherein the second photon detector includes a filter configured to pass photons having the second wavelength and block photons having the first wavelength.

12. The system of claim 7, wherein the one or more trapped ions is a barium ion, a ytterbium ion, a calcium ion, a strontium ion, or a radium ion.

13. A method for background-free measurement of qubit states, the method comprising:
controlling a photon source to produce photons having a first wavelength for a first time period, wherein the photon source is oriented such that the photons having the first wavelength are directed towards one or more ions in an ion trap;
activating a photon detector configured to detect photons having a second wavelength during the first time period, the second wavelength being different than the first wavelength;
stopping the photon source from producing photons having the first wavelength;
stopping the photon detector from detecting photons having the second wavelength;
activating a photon detector configured to detect photons having the first wavelength;
controlling the photon source to produce photons having the second wavelength for a second time period;
detecting, with the photon detector, photons having the first wavelength during the second time period; and
determining, based on detection of photons having the first wavelength during the second time period or based on detection of photons having the second wavelength during the first time period, that at least one of the one or more ions is in a |1 [symbol] state.

14. The method of claim 13, wherein photons having the first wavelength cause the one or more ions to transition from a ground state to an excited state; and
wherein photons having the second wavelength cause the one or more ions to transition from a meta-stable state to the excited state.

15. The method of claim 14, wherein photons having the first wavelength detected during the second time period are emitted by at least one of the one or more ions transitioning from the excited state to the ground state.

16. The method of claim 14, wherein photons having the second wavelength detected during the first time period are emitted by at least one of the one or more ions transitioning from the excited state to the meta-stable state.

17. The method of claim 13, wherein the one or more ions is a barium ion, a ytterbium ion, a calcium ion, a strontium ion, or a radium ion.

18. The method of claim 13, wherein the photon detector configured to detect photons having the first wavelength includes a filter configured to pass photons having the first wavelength and block photons having the second wavelength.

19. The method of claim 13, wherein the photon detector configured to detect photons having the second wavelength includes a filter configured to pass photons having the second wavelength and block photons having the first wavelength.

20. The method of claim 13, wherein the method is a computer-implemented method.
